(19) United States
(12) Patent Application Publication
(10) Pub. No.: US 2010/0250365 A1
(43) Pub. Date: Sep. 30, 2010

(54) AD GROUPS FOR USING ADVERTISEMENTS ACROSS PLACEMENTS

(75) Inventors: Vivek Hariharan, Sunnyvale, CA (US); Brian Lam, San Jose, CA (US); Durgadatt R. Kamath, Cupertino, CA (US); Graham S.T. Harris, Westlake Village, CA (US)

Correspondence Address: FIALA & WEAVER, P.L.L.C.;C/O CPA GLOBAL, P.O. BOX 52050, MINNEAPOLIS, MN, 55402, US

(73) Assignee: YAHOO! INC., Sunnyvale, CA (US)

(21) Appl. No.: 12/410,843

(22) Filed: Mar. 25, 2009

(51) Int. Cl. G06Q 30/00; G06F 3/048

(52) U.S. Cl. 705/14.53; 715/810

(57) ABSTRACT

Advertisements are enabled to be trafficked to an ad group having multiple associated placements. A user interface is configured to enable an ad group and an online advertisement to be selected. The selected ad group has an associated plurality of advertisement placements. An ad group modifier module is configured to associate the selected online advertisement with the selected ad group.

### BACKGROUND OF THE INVENTION

1. Field of the Invention

The present invention relates to online advertising.

2. Background

According to one definition, advertising is a paid, one-way communication through a medium in which an advertiser is identified, and the message (i.e., the advertisement) provided by the advertiser is controlled. Advertising may be performed for a variety of purposes, including publicity, public relations, product placement, sponsorship, underwriting, and sales promotion. A variety of mediums are used to convey an advertisement, including television, radio, movies, magazines, newspapers, the Internet, and billboards.

Online advertising relates to the promoting of products and services using the Internet and World Wide Web. Online advertising generally includes displaying an advertisement for a product or service in a user's browser when the user is navigating the Internet. A particular advertisement that is displayed at a given time may have been selected based upon an online context into which the user has navigated, or in some instances upon a historical record of the user's online navigation behavior. When a user clicks on a displayed advertisement, the user may be directed to a website specific to the advertisement, or may be directed to a website that enables purchase of the product or service that is advertised. Typical online advertisement types include banner ads, floating ads, pop-up ads, and video ads which are provided through a browser to the user's computer desktop.

A business or other entity may generate a portfolio of advertisements available to be displayed online. The advertisements may be configured to advertise various services and/or products of the business, and may be configured to associate with various online contexts, enabling the advertisements to be targeted based on the online navigation behavior of users. The business may contract to have their advertisements displayed at the online locations (e.g., web pages) of any number of content publishers. Currently, a particular advertisement is contracted to be published at a designated online location, such as “the North banner location of the Yahoo!® home page” or other particular online location. Such one-to-one trafficking of advertisements to particular online locations is inefficient. More efficient ways of providing advertisements for display at online locations are desired.

### BRIEF SUMMARY OF THE INVENTION

Advertisements are enabled to be trafficked to groups of online advertisement locations (which may also be referred to as online “placements” or “inventory”) by “ad groups.” An ad group is associated with a plurality of advertisement placements. One or more advertisements are trafficked into the ad group. When an advertisement is requested for a placement associated with the ad group, an advertisement may be selected from the ad group to be provided in response to the request.

In one implementation, an advertisement trafficking system is provided. The advertisement trafficking system includes a user interface and an ad group modifier module. The user interface is configured to enable an ad group and an online advertisement to be selected. The selected ad group has an associated plurality of advertisement placements. The ad group modifier module is configured to associate the selected online advertisement with the selected ad group.

In another implementation, a method for trafficking advertisements is provided. An indication of an ad group is received, the ad group having an associated plurality of advertisement placements. The ad group may be selected from a plurality of ad groups, for instance. An indication of an online advertisement is received. The online advertisement may be enabled to be selected from a plurality of online advertisements. The online advertisement is associated with the indicated ad group.

An advertisement specification may be associated with an ad group based on the advertisement placements associated with the ad group. For example, the advertisement specification may include one or more required advertisement parameters, such as an advertisement size, an advertisement weight, or an advertisement format. In one aspect, an online advertisement trafficked into the ad group may meet the advertisement specification of the ad group. In another aspect, an online advertisement may be trafficked into an ad group even though the online advertisement violates the advertisement specification.

Computer program products are also described herein. The computer program products include a computer-readable medium having computer program logic recorded thereon for enabling advertisements to be trafficked into ad groups.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 shows a block diagram of a computer that a user may use to view content.

FIG. 2 shows an example search results page that may result from a user submitting a query to a search engine.

FIG. 3 is a block diagram of an example online advertisement (“ad”) network in accordance with an embodiment of the present invention.

FIG. 4 shows a block diagram of a system for trafficking an ad into an ad group, according to an example embodiment of the present invention.

FIG. 5 shows a flowchart for trafficking advertisements, according to an example embodiment of the present invention.

FIG. 6 shows a block diagram of an advertisement trafficking module, according to an example embodiment of the present invention.

FIG. 7 shows an advertisement library page that may be provided by a user interface, according to an example embodiment of the present invention.

FIG. 9 shows a process for indicating an ad group, according to an example embodiment of the present invention.

FIGS. 8 and 10-17 show views of an “assign to ad group” page that may be provided by a user interface, according to example embodiments of the present invention.

FIG. 18 shows a flowchart for enabling advertisements to be selected for trafficking to an ad group, according to an example embodiment of the present invention.

FIGS. 19 and 20 show views of an ad group details page, according to an example embodiment.

FIG. 21 shows a block diagram of an example computer system in which embodiments of the present invention may be implemented.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

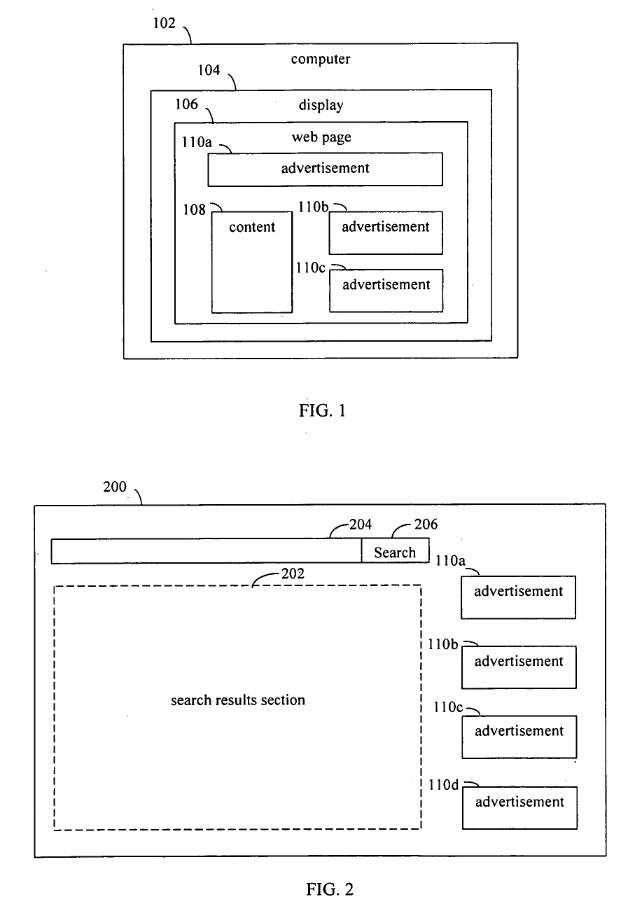

Embodiments of the present invention relate to online advertising, including advertising in the form of contextual advertising and sponsored search. FIGS. 1 and 2 show examples of the displaying of advertisements in contextual advertising and sponsored search environments. For instance, FIG. 1 shows a block diagram of a computer 102 that a user may use to view online content. As shown in FIG. 1, a display 104 of computer 102 displays a web page 106 open in a web browser. As shown in FIG. 1, web page 106 includes content 108. Furthermore, web page 106 may include any number and arrangement of advertisements, including advertisements 110a-110c shown in FIG. 1. Advertisements 110a-110c may have any suitable form, including being banner ads, floating ads, pop-up ads, and video ads. In the example of FIG. 1, advertisement 110a is shown as a banner ad at the top of web page 106 (e.g., a North banner advertisement), and advertisements 110b and 110c are both positioned adjacent to a right edge of web page 106.

FIG. 2 shows an example search results page 200 that may result from a user submitting a query to a search engine. Search results page 200 may also be displayed by computer 102 of FIG. 1. As shown in FIG. 2, search results page 200 includes a search results section 802, a data entry box 204, and a search button 206. Data entry box 204 defines a user-editable area into which one or more query terms may be entered. When activated, search button 206 causes the search engine to execute a document search based on the query term(s) entered in data entry box 204. Search results section 202 is used to display information about documents identified by the search engine in response to the submitted search query. Search results page 200 may include any number and arrangement of advertisements, including advertisements 110a-110d shown in FIG. 2. Advertisements 110a-110d may be sponsored search ads associated with particular queries, for example.

An entity, such as a business, may generate a portfolio of advertisements available to be displayed online on web pages, such as web page 106 and search results page 200. The entity may contract to have their advertisements displayed at online locations of any number of content publishers, by placing an order. Currently, in an order, a particular advertisement is contracted to be published at a particular online location. For example, an advertisement may be contracted to be displayed at “the North banner location of the Yahoo!® home page” or other particular online location. Such one-to-one trafficking of advertisements to particular online locations is inefficient. Embodiments of the present invention enable advertisements to be efficiently trafficked so that they may be displayed at multiple online locations.

Examples of such embodiments are described in detail below.

### II. Example Embodiments

Embodiments of the present invention enable advertisements to be made available for display to multiple online advertisement locations. Online advertisement locations are also referred to herein as online “placements” or “inventory.” In an embodiment, an ad group is associated with a plurality of advertisement placements. The ad group may be configured with one or more advertisement properties (e.g., advertisement sizes, placement locations, etc.) and one or more target attributes (e.g., target user demographics, etc.). Online advertisements are enabled to be trafficked into the ad group, so that the online advertisements are available to be displayed at the online placements upon request. When an advertisement is requested for display, if the ad group is determined to meet the requirements of the request, an advertisement may be selected from the ad group to be provided in response to the request.

Example embodiments are described below for trafficking online advertisements into ad groups. For illustrative purposes, some example embodiments are described with regard to the display of advertisements in web pages. However, in alternative embodiments, advertisements as described herein may be displayed in other electronic form, including in widgets (e.g., desktop widgets such as Yahoo!® Widgets, Google® panels or gadgets, etc.), in text messages, and/or in/with other electronic content.

A. Example Online Ad Network Embodiments

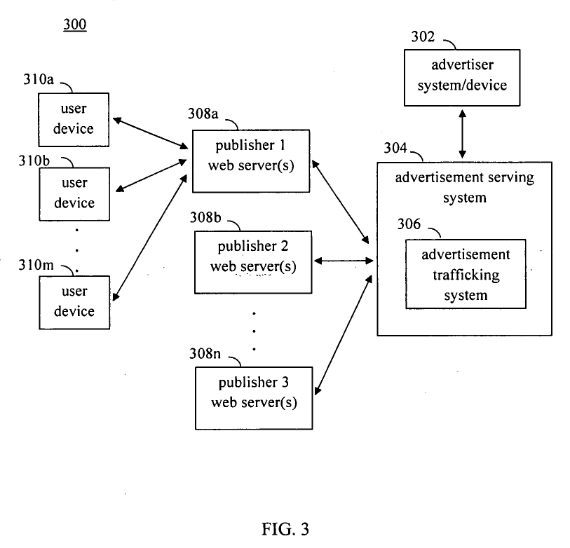

FIG. 3 is a block diagram of an example online advertisement (“ad”) network in accordance with an embodiment of the present invention. Generally speaking, online ad network 300 operates to serve online ads provided by advertisers to Web sites published by publishers when such Web sites are accessed by users of the network, thereby delivering the online ads to the users. As shown in FIG. 3, online ad network 300 includes at least one advertiser system/device 302, an ad serving system 304, a plurality of publisher Web servers 308a-308n, and a plurality of user systems/devices 310a-310m.

Each of publisher Web servers 308a-308n is configured to host a Web site published by a corresponding publisher so that such Web site is accessible to users of network 300. A user may access such Web sites using a Web browser or other Web client installed on a system/device owned by or otherwise accessible to the user. By way of example, FIG. 3 shows a plurality of user systems/devices 310a-310m, each of which executes a Web browser that enables a user to visit any of the Web sites hosted by publisher Web servers 308a-308n. As depicted in FIG. 3, each of client systems/devices 310a-310m is communicatively connected to publisher 1 Web server(s) 308a for the purpose of accessing a Web site published by publisher 1. Persons skilled in the relevant art(s) will recognize that each of user systems/devices 310a-310m is capable of connecting to any of publisher Web servers 308a-308n to access the Web sites hosted thereon. Communication between user systems/devices 310a-310m and publisher Web servers 308a-308n is carried out over a wide area network, such as the Internet, using well-known network communication protocols.

Ad serving system 304 is configured to deliver online ads received from an advertiser system/device 302 to each of publisher Web servers 308a-308n when the Web sites hosted by such Web servers are accessed by users, thereby facilitating the delivery of such online ads to the users. Before the online ads can be delivered to publisher Web servers 308a-308n, however, the online ads are trafficked with regard to respective placements. A placement represents a publisher's agreement to serve a trafficked ad to users when the users visit the publisher's site. In embodiments, online ads may be organized and trafficked in groups, termed ad groups. An ad group may comprise, for example, a collection of online ads having a similar target audience and/or pricing model.

As shown in FIG. 3, ad serving system 304 includes an advertisement trafficking system 306. Advertisement trafficking system 306 enables online ads to be trafficked with regard to respective placements by enabling online ads to be trafficked to ad groups. By trafficking an online ad to an ad group, the online ad is made available to be served to the placements associated with the ad group.

B. Example Advertisement Trafficking System and Method Embodiments

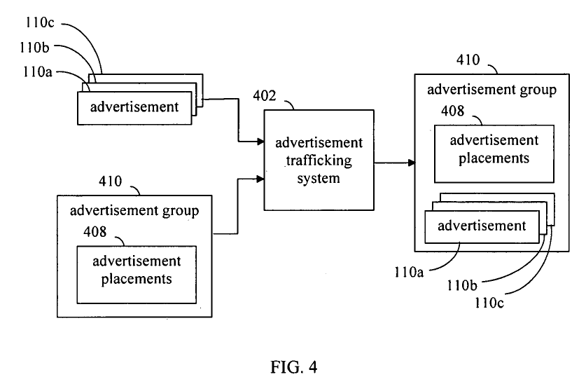

FIG. 4 shows a block diagram of an implementation of advertisement trafficking system 306, according to an example embodiment. In FIG. 4, an advertisement trafficking module 402 receives an advertisement group (ad group) 410 and one or more advertisements 110a-110c. As shown in FIG. 4, ad group 410 includes advertisement placements 408. Advertisement placements 408 include designations for a plurality of online advertisement locations at which advertisements may be displayed. For example, advertisement placements 408 may include online advertisement locations reserved or purchased (or otherwise compensated for) by an advertising entity or advertiser. As used herein, “advertiser” refers to an entity that supplies online advertisements for display for itself or on behalf of another entity. Advertisement trafficking module 402 traffics one or more of advertisements 110a-110c into ad group 410.

Although three advertisements 110a-110c are shown in FIG. 4 for illustrative purposes, any number of advertisements 110 may be trafficked, including tens, hundreds, thousands, and even larger numbers of advertisements. Advertisements 110 may be of any online advertisement type, including being standard graphical advertisements, video advertisements, rich media advertisements, Adobe® Flash® advertisements, HTML (hypertext markup language) advertisements, etc. Examples of standard graphical advertisements include advertisements in the form of images such as JPEG (joint photographic experts group) format or GIF (graphics interchange format) files. Video advertisements may have any suitable video format, including being MPEG format files. Adobe® Flash® advertisements may be configured as SWF (shockwave flash) format files, for instance. Advertisements 110 may be dynamic or static. Advertisements 110 may each have the form of one or more files and/or other data structures stored in database 404.

Subsequent to trafficking advertisements 110 into ad group 410, advertisements 110 may be served to advertisement placements 408 included in ad group 410. Referring to FIG. 3, an advertisement request may be received by advertisement serving system 304. The advertisement request includes a request for an advertisement to be displayed at a particular online location (e.g., a request for an advertisement “impression”). Advertisement serving system 304 is configured to determine whether advertisement placements 408 of ad group 410 include the online location included in the advertisement request, and whether ad group 410 matches desired advertisement criteria provided in the request, including properties of the request such as ad size, ad weight, and/or ad format. If ad group 410 has a specification that meets the criteria, advertisement serving system 304 analyzes each online advertisement of the ad group to determine which advertisements meet the criteria, and selects an online advertisement from the advertisements that meet the criteria. Advertisement serving system 304 transmits the selected online advertisement to be displayed at the online location of one of web servers 308a-308n by one of user devices 310a-310m, and may be interacted with by a user if the user so desires.

Note that advertisement serving system 304, advertisement trafficking system 306, and advertisement trafficking module 402 may be implemented in hardware, software, firmware, or any combination thereof. For example, advertisement serving system 304, advertisement trafficking system 306, and advertisement trafficking module 402 may be implemented in hardware logic, and/or may include software/firmware that executes in one or more processors of one or more computer systems, such as one or more servers. Alternatively, advertisement serving system 304, advertisement trafficking system 306, and advertisement trafficking module 402 may be implemented as hardware logic/electrical circuitry. In an embodiment, advertisement trafficking module 402 may be included in a computer-based tool, such as an advertisement or “creative” management tool. A creative management tool may be used to perform various management functions for advertisements, including managing the components (“creatives”) of online advertisements, enabling advertisements to be generated/edited, managing folders of completed advertisements, managing orders for advertisements, etc.

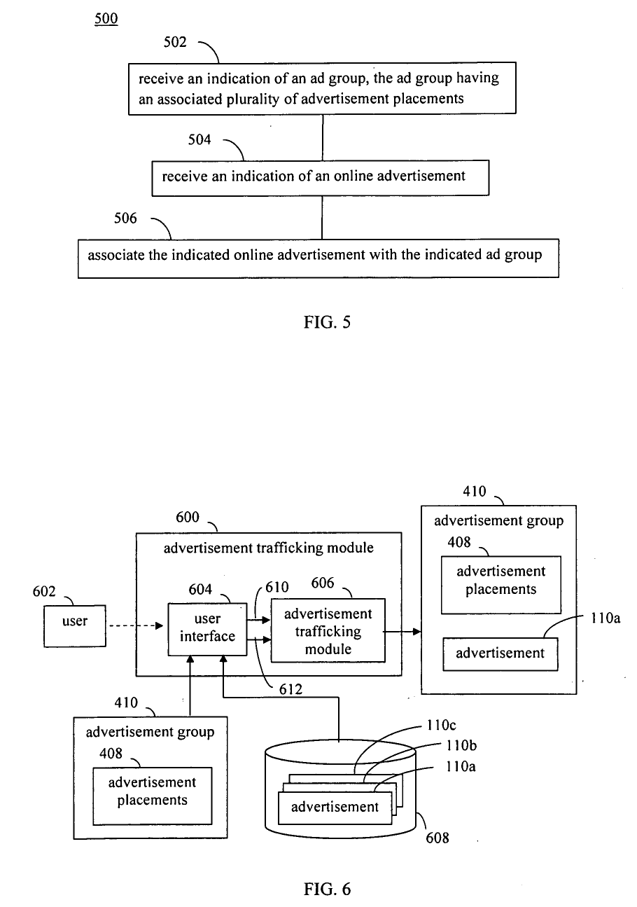

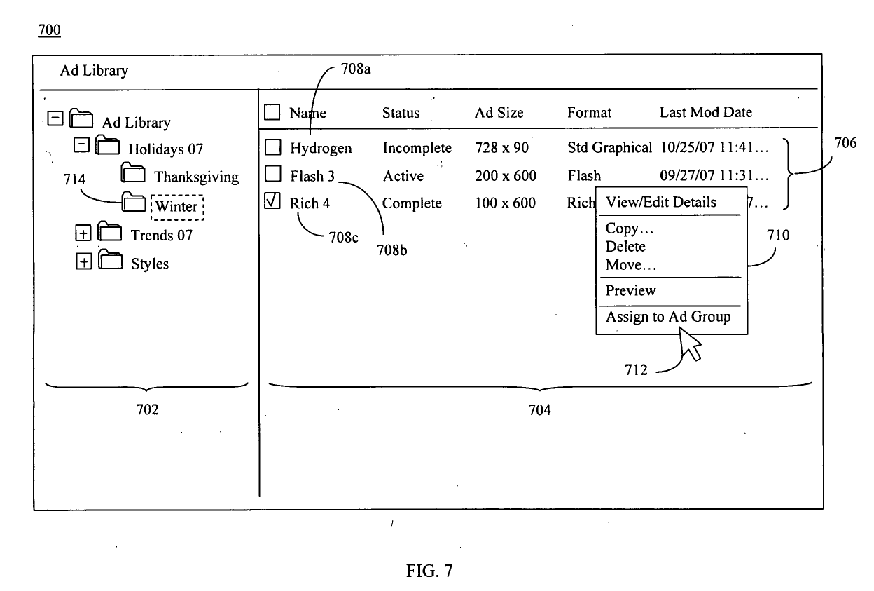

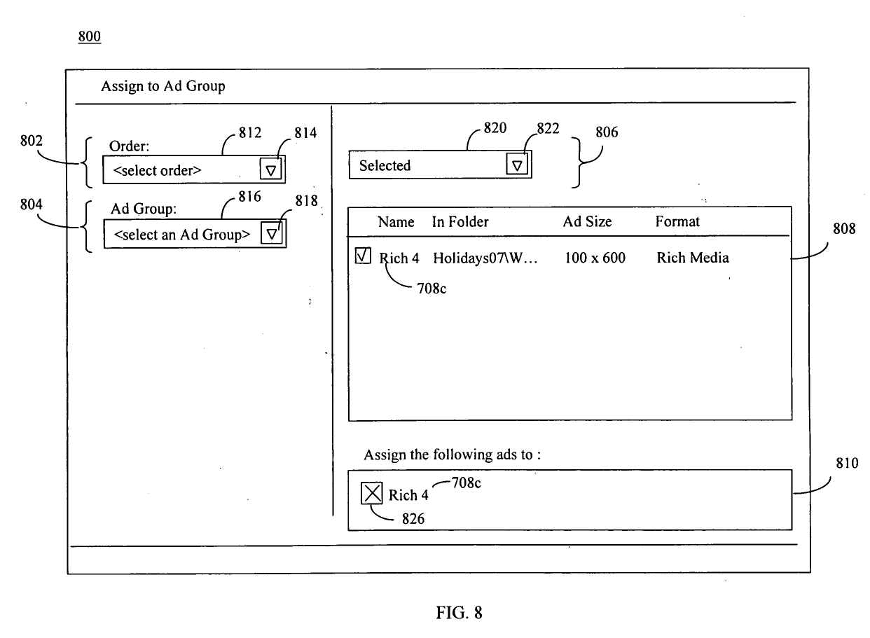

Advertisement trafficking module 402 shown in FIG. 4 may be configured to perform its functions in any suitable manner. For example, FIG. 5 shows a flowchart 500 for trafficking advertisements, according to an example embodiment of the present invention. Further structural and operational embodiments will be apparent to persons skilled in the relevant art(s) based on the discussion regarding flowchart 500. For instance, flowchart 500 is described with reference to an advertisement trafficking module 600 shown in FIG. 6, for illustrative purposes. Advertisement trafficking module 600 is an example of advertisement trafficking module 402 shown in FIG. 4. As shown in the embodiment of FIG. 6, advertisement trafficking module 600 includes a user interface 604 and an ad group modifier module 606. Flowchart 500 is described as follows.

Flowchart 500 begins with step 502. In step 502, an indication of an ad group is received, the ad group having an associated plurality of advertisement placements. For example, as shown in FIG. 6, a user 602 may interact with user interface 604 to select an ad group, such as ad group 410. As shown in FIG. 6, ad group 410 includes advertisement placements 408. User 602 acts on behalf of an advertiser. For example, user 602 may interact with user interface 604 at advertiser system/device 302 shown in FIG. 3. User interface 604 may include any number and combination of user interface elements, such as a keyboard, a thumb wheel, a mouse pointer, a roller ball, a stick pointer, a display, any number of virtual interface elements, a voice recognition system, a haptic interface, and/or other user interface elements described elsewhere herein or otherwise known. Such user interface elements may be used to enable the user to select an ad group. For instance, user interface 604 may provide a graphical user interface (GUI) to user 602, such as a web page displayed in a web browser. User 602 may be enabled by user interface 604 to select ad group 410 from a plurality of ad groups that may be displayed to user 602 in the form of a list, or in other form. As shown in FIG. 6, user interface 604 generates a selected ad group indication signal 610.

In step 504, an indication of an online advertisement is received. For example, as shown in FIG. 6, user 602 may interact with user interface 604 to indicate an online advertisement, such as advertisement 110a. For instance, user interface 604 may provide a graphical user interface (GUI) to user 602, such as a web page displayed in a web browser. User 602 may be enabled by user interface 604 to select advertisement 110a from advertisements 110a-110c, which may be displayed to user 602 in the form of a list, or in other form. In the embodiment of FIG. 6, advertisements 110a-110c (and possibly further advertisements) may be accessed in an advertisement database 608. As shown in FIG. 6, user interface 604 generates a selected advertisement indication signal 612.

In step 506, the indicated online advertisement is associated with the indicated ad group. As shown in FIG. 6, ad group modifier module 606 receives selected ad group indication signal 610 and selected advertisement indication signal 612. Ad group modifier module 606 associates the advertisement indicated by selected advertisement indication signal 612 (e.g., advertisement 110a) with the ad group indicated by selected ad group indication signal 610 (e.g., ad group 410). As shown in FIG. 6, ad group modifier module 606 generates a version of ad group 410 that includes advertisement 110a (and may include additional online advertisements). For example, ad group modifier module 606 may modify a data structure (e.g., one or more files) representative of ad group 410 to include a reference to advertisement 110a. In this manner, advertisement 110a is trafficked into ad group 410.

C. Example User Interface Embodiments

Various example ways for trafficking advertisements into ad groups according to the description provided above are described as follows. Examples user interfaces that enable trafficking of advertisements are described as follows. Such examples are provided for illustrative purposes, and are not intended to be limiting.

For instance, FIG. 7 shows an advertisement library page 700 that may be provided by user interface 604 of FIG. 6, according to an embodiment. User 602 may interact with advertisement library page 700 to select one or more advertisements (according to step 502 of flowchart 500). Advertisement library page 700 may be a tool window, a web page, or may be another type of graphical user interface. As shown in FIG. 7, advertisement library page 700 includes an ad directory section 702 and an advertisement list section 704. As shown in FIG. 7, ad directory section 702 shows a hierarchical tree of folders, where each folder shown in section 704 may store respective advertisements. Each folder displayed in directory section 704 may be selected to display any advertisements stored therein in advertisement list section 704.

In the example of FIG. 7, ad directory section 702 includes a top level folder labeled “Ad Library,” which contains the folders “Holiday 07,” “Trends 07,” and “Styles” as subfolders. The folder “Holidays 07” includes a folder labeled “Thanksgiving” and a folder 714 that is labeled “Winter.” Folder 714 is indicated as selected in FIG. 7. Because folder 714 is selected, a list 706 of three advertisements 708a-708c contained in folder 714 is displayed in advertisement list section 704. Information for each advertisement 708 contained in list 706 is shown by column in section 704, including a “Name,” “Status,” “Ad Size,” “Format,” and “Last Mod Date” for each advertisement 708. First advertisement 708a is named “Hydrogen” and is a standard graphical format advertisement. Second advertisement 708b is named “Flash 3” and is a Flash format advertisement. Third advertisement 708c is named “Rich 4” and is a rich media object format advertisement.

In the current example, it is desired to traffic an advertisement, such as third advertisement 708c, into an ad group. To traffic third advertisement 708c into an ad group, third advertisement 708c may be selected in FIG. 7 (e.g., using a mouse pointer or other technique) to cause a menu 710 to be displayed. Menu 710 may list various options with regard to third advertisement 708c, including an “Assign to Ad Group” option. In FIG. 7, a pointer 712 is shown that is being used to click on the “Assign to Ad Group” option in menu 710 to enable third advertisement 708c to be indicated (according to step 502) for trafficking into an ad group.

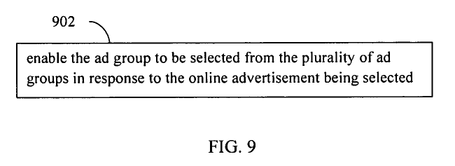

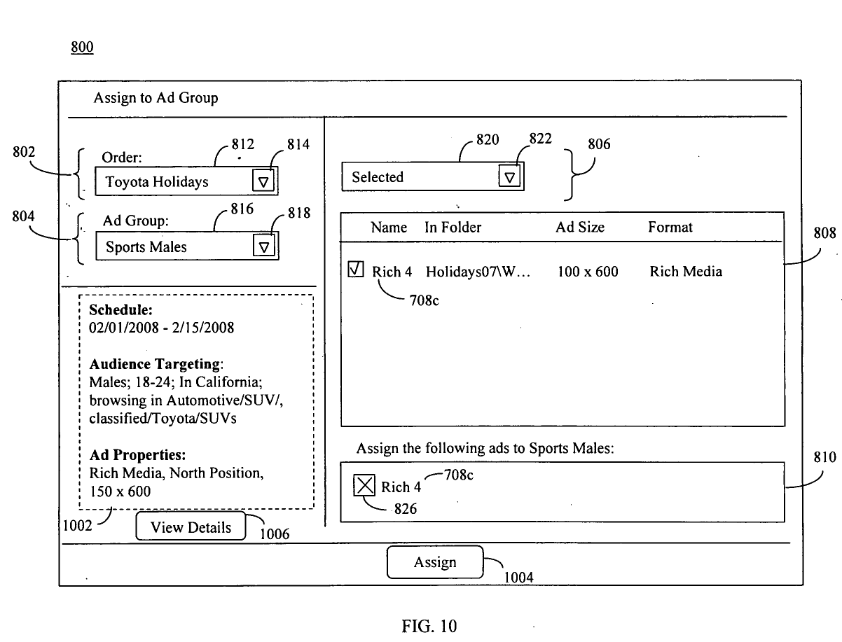

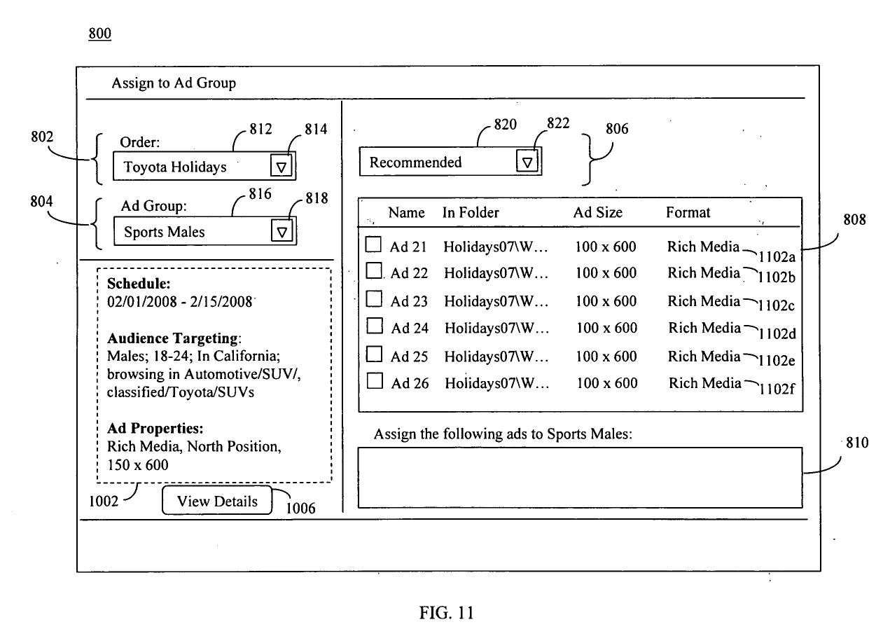

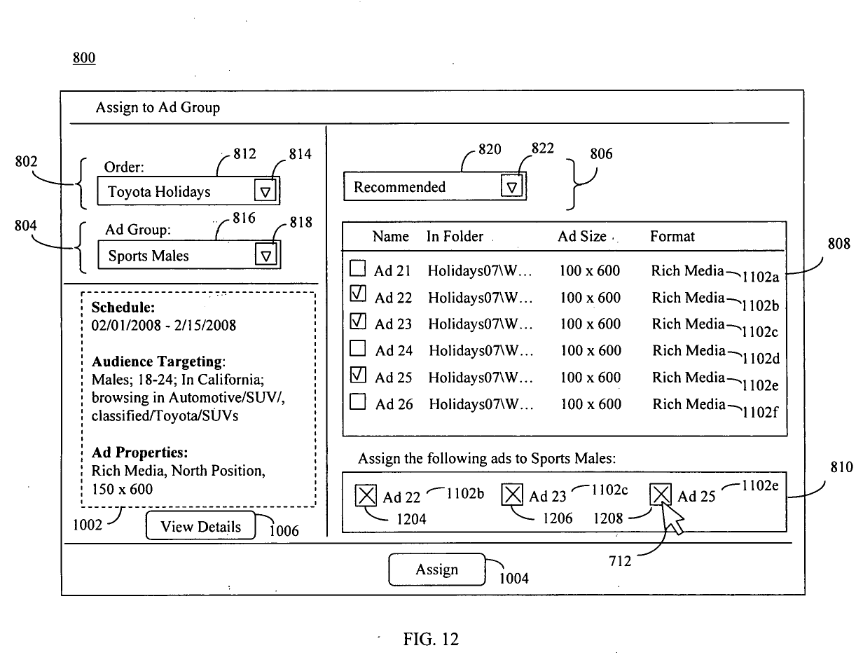

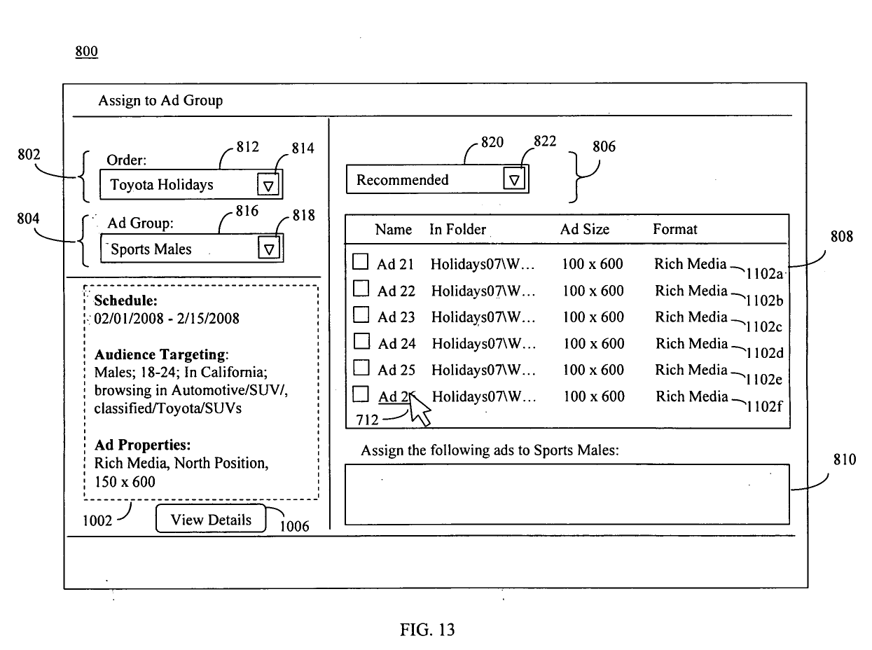

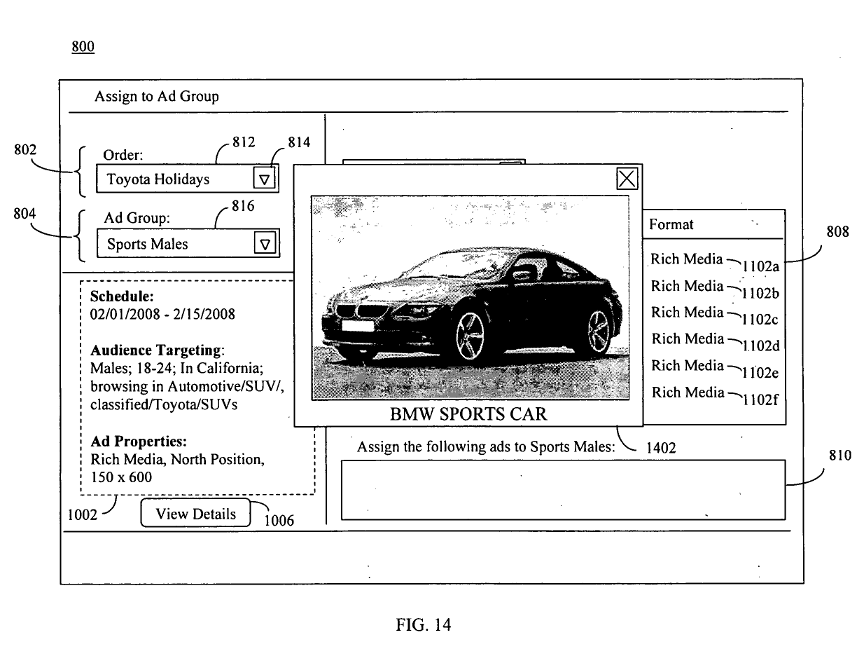

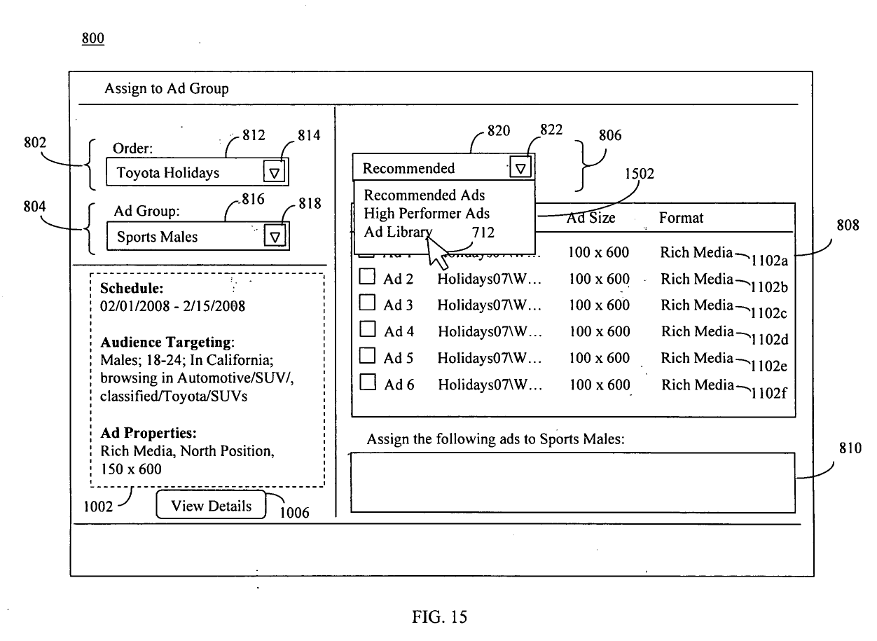

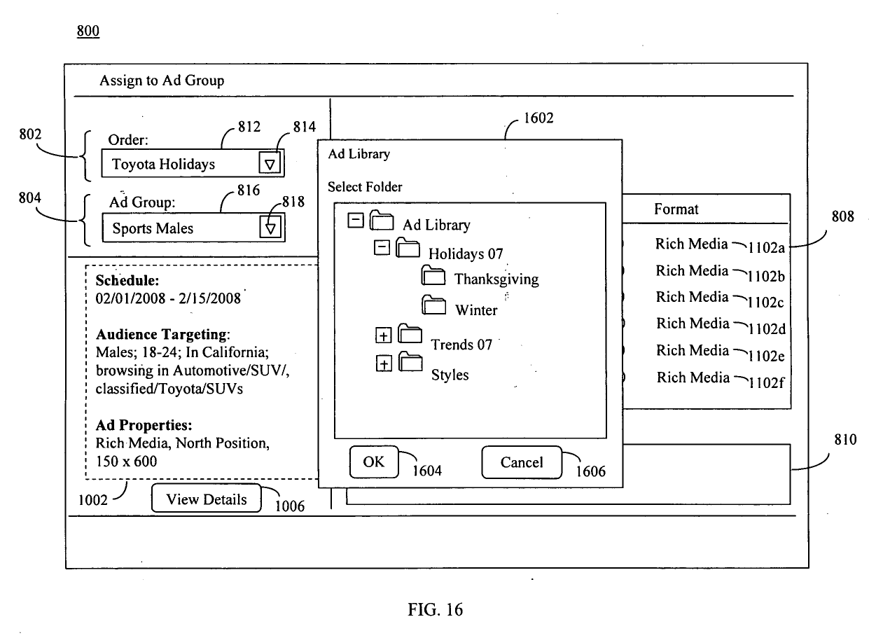

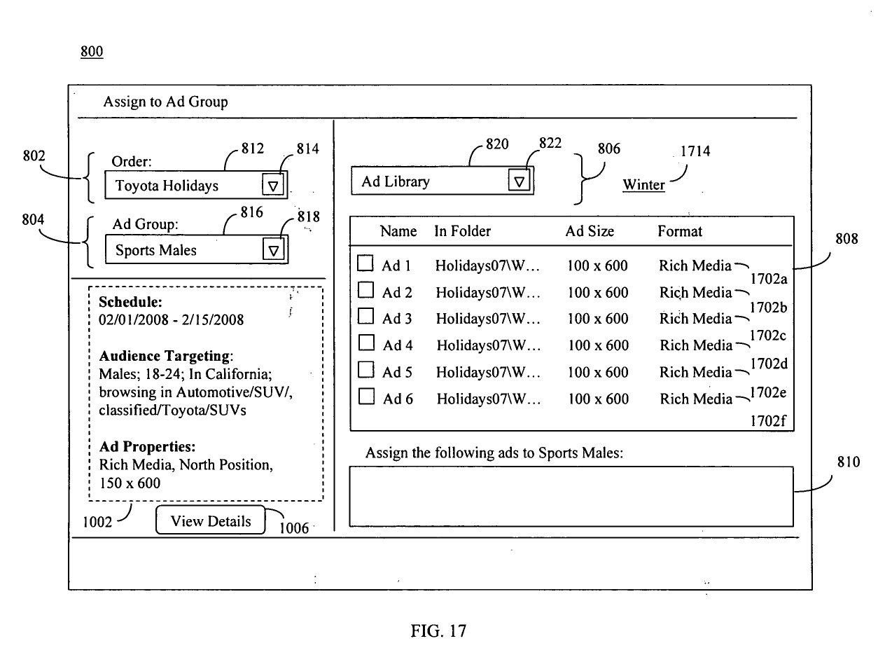

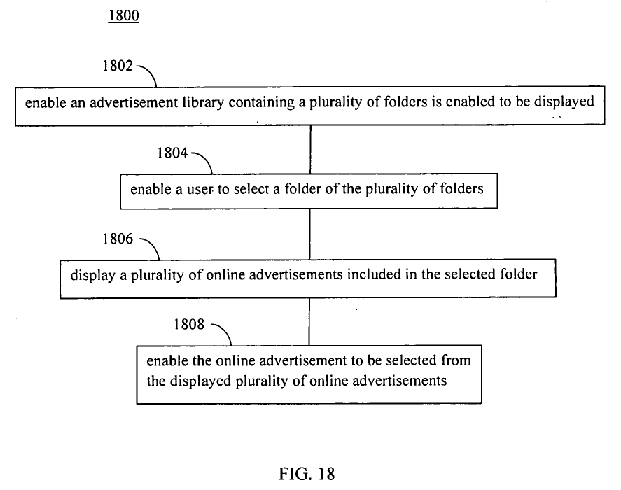

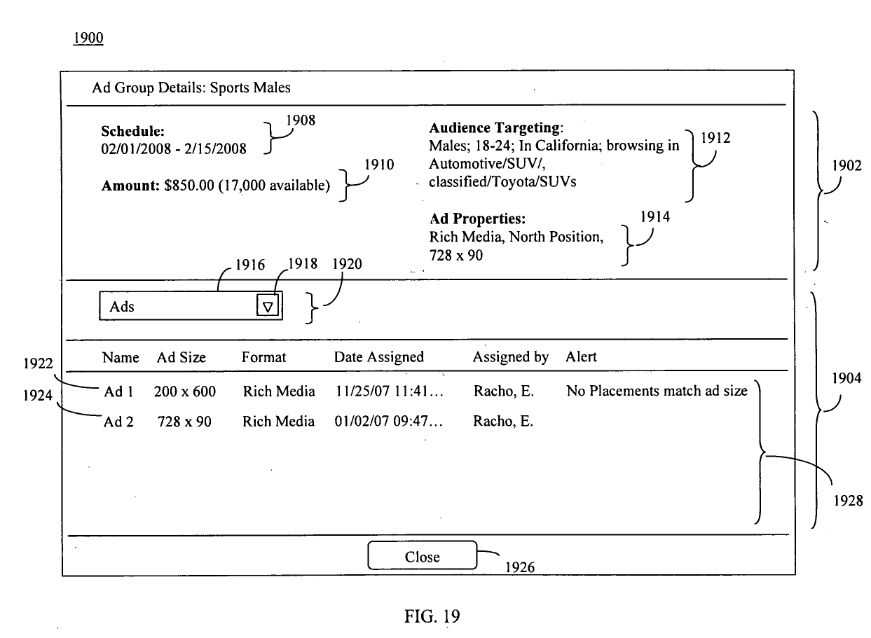

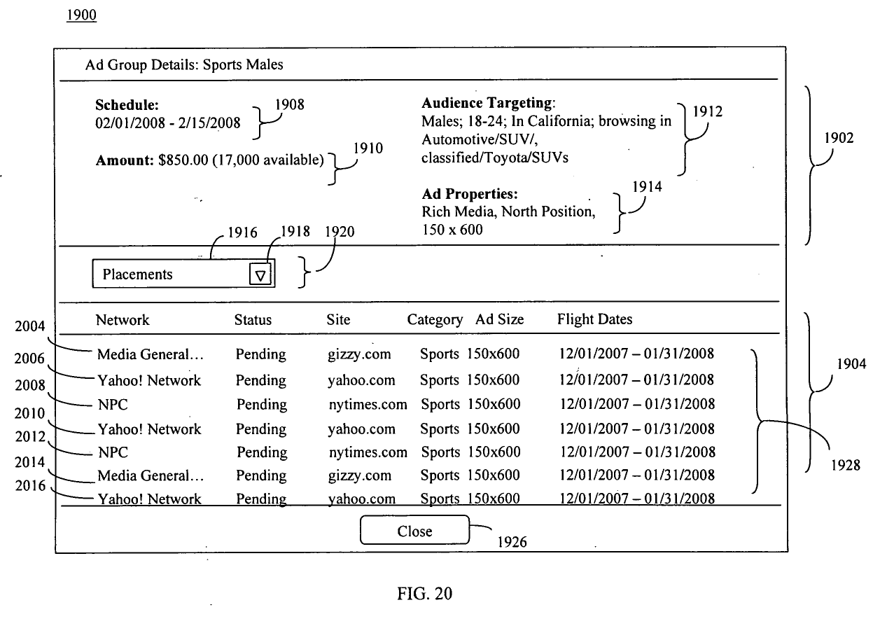

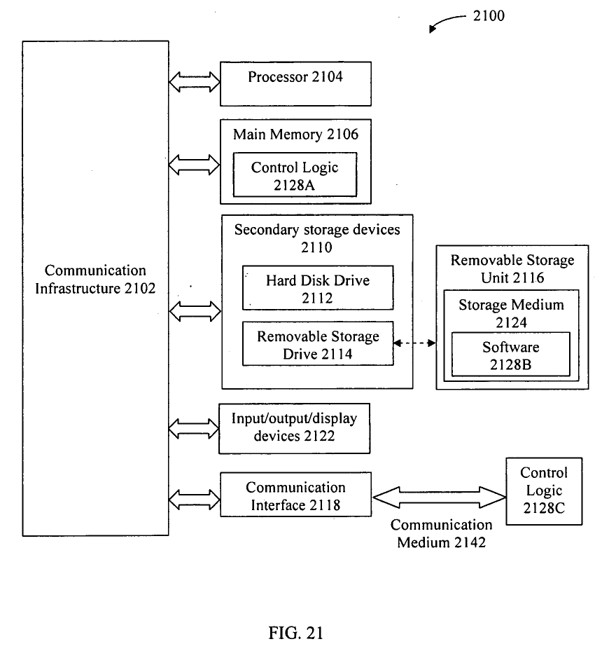

In response to selecting the “Assign to Ad Group” option in menu 710, an “assign to ad group” page 800 shown in FIG. 8 may be provided by user interface 604, according to an embodiment. Page 800 may be a tool window, a web page, or may be another type of graphical user interface. User 602 may interact with page 800 to be enabled to indicate an ad group (according to step 504 of flowchart 500), and to cause the selected advertisement to be trafficked to the selected ad group (according to step 506 of flowchart 500). In an embodiment, page 800 enables step 504 of flowchart 500 (FIG. 5) to be performed according to a step 900 shown in FIG. 9. Referring to FIG. 9, in step 900, the ad group is enabled to be selected from the plurality of ad groups in response to the online advertisement being selected. In response to selecting advertisement 708c in page 700 of FIG. 7, page 800 is displayed, which enables an ad group to be selected from a plurality of ad groups.

As shown in FIG. 8, “assign to ad group” page 800 includes a select order section 802, a select ad group section 804, a view selector section 806, an advertisement list section 808, and an assigned advertisement section 810. Sections 802, 804, 806, 808, and 810 may each include one or more respective graphical interface elements to enable respective data to be defined/input, including a data entry box, a pull down menu, and/or other graphical interface element type. For example, section 802 is shown in FIG. 8 as including a select order box 812 and a pull down menu button 814. User 602 shown in FIG. 6 may interact with pull down menu button 814 to cause a list of advertisement orders to appear. User 602 may select one of the advertisement orders so that ad groups associated with the selected advertisement campaign order will be selectable in section 804. Section 804 is shown in FIG. 8 as including a select ad group box 816 and a pull down menu button 818. User 602 shown in FIG. 6 may interact with pull down menu button 818 to cause a list of ad groups associated with the advertisement campaign order selected in section 802 to appear. User 602 may select one of the listed ad groups so that advertisements may be assigned to the selected ad group.

As shown in FIG. 8, advertisement 708c, which was selected to be assigned to an ad group (as shown in FIG. 7), is listed in both of sections 808 and 810. Section 808 lists advertisements that may be selected for assignment to an ad group, and section 810 lists advertisements that are selected to be assigned to an ad group.

FIG. 10 shows page 800 of FIG. 8, where select order box 812 indicates that “Toyota Holidays” is selected as a current order, and select ad group box 816 indicates that “Sports Males” is selected as a current ad group. In the embodiment of FIG. 10, properties and attributes of the selected ad group are displayed in an ad group characteristics section 1002 of page 800. For example, section 1002 displays schedule information (e.g., the advertisements of the ad group are scheduled for display during the date range of Feb. 1, 2008-Feb. 15, 2008), target audience attributes (e.g., a sex demographic of male, age group of 18-24, a location of California, and subject matter of “browsing in Automotive/SUV/, classified/Toyota/SUVs”), and advertisement properties (e.g., rich media format, North banner position, and an advertisement size of 150×600 pixels) for the “Sports Males” ad group.

In the example of FIG. 10, advertisement 708c is listed in section 810, and is thus selected to be assigned to the “Sports Males” ad group (advertisement 708c may be removed from section 810 by interacting with a delete button 826 adjacent to the listing of advertisement 708c in section 810). If user 602 shown in FIG. 6 interacts with an “Assign” button 1004 displayed in page 800, ad group modifier module 606 (FIG. 6) associates any advertisements shown listed in section 810 with the selected ad group. In such case, ad group modifier module 606 shown in FIG. 6 is configured to generate a version of ad group 410 to include the online advertisement(s) selected according to step 502.

Ad group modifier module 606 may be implemented in hardware, software, firmware, or any combination thereof. For example, ad group modifier module 606 may be implemented in hardware logic, and/or may include software/firmware that executes in one or more processors of one or more computer systems, such as one or more servers. Alternatively, ad group modifier module 606 may be implemented as hardware logic/electrical circuitry.

Note that advertisements may be indicated for ad groups (in step 502) in further ways. For example, referring to FIGS. 7, 8, and 10, advertisement 708c was selected for assignment to an ad group by selecting advertisement 708c in ad library page 700 (FIG. 7), and clicking on “Assign to Ad Group” in menu 710. Section 806 is shown in FIG. 8 as including a select ad source box 822 and a pull down menu button 822. Because advertisement 708c was selected for display in page 800 in FIG. 8 by selecting advertisement 708c in ad library page 700, select ad source box 822 displays “Selected.” In another embodiment, user 602 shown in FIG. 6 may interact with pull down menu button 822 to enable other sources for advertisements to be provided.

In another embodiment, FIG. 11 shows page 800, where user 602 has interacted with pull down menu button 822 to cause “Recommended” to be displayed in select ad source box 822. In such case, a listing of recommended advertisements is displayed in section 808. The list of recommended advertisements may be generated by automated searching of one or more advertisement libraries (e.g., advertisement database 404 shown in FIG. 6) for advertisements that match desired advertisement criteria. For example, an advertisement library may be searched for advertisements matching one or more advertisement properties assigned to the ad group (e.g., as described above with respect to step 506 of FIG. 5), including advertisement size, format, etc. In the example of FIG. 11, six advertisements 1102a-1102f are displayed in section 808, for illustrative purposes. Advertisements 1102a-1102f are recommended advertisements for the current ad group, “Sports Males,” matching the advertisement properties the ad group - rich media format and no more than a 150 x 600 pixel area. Examples techniques for providing recommendations for trafficking online advertisements are described in commonly assigned, co-pending U.S. application Ser. No. [to be assigned], titled “Providing Recommendations for Trafficking Online Ads in an Online Ad Network,” which is incorporated by reference herein in its entirety.

One or more of advertisements 1102a-1102f may be indicated for inclusion in the ad group, “Sports Males,” according to step 504 of FIG. 5. For example, FIG. 12 shows a view of page 800, where advertisements 1102b, 1102c, and 1102e are selected in section 808 (as indicated by respective checked boxes), and thus are each displayed in section 810. Because advertisements 1102b, 1102c, and 1102e are listed in section 810, if user 602 shown in FIG. 6 interacts with an “Assign” button 1004 displayed in page 800, advertisements 1102b, 1102c, and 1102e are assigned to the “Sports Males” ad group (e.g., ad group modifier module 606 shown in FIG. 6 associates advertisements 1102b, 1102c, and 1102e with the “Sports Males” ad group).

As shown in FIG. 12, a delete button 1204 is displayed adjacent to the listing of advertisement 1102b, a delete button 1206 is displayed adjacent to the listing of advertisement 1102c, and a delete button 1208 is displayed adjacent to the listing of advertisement 1102e. By interacting with one of delete buttons 1204, 1206, or 1208, the listing of the respective one of advertisements 1102b, 1102c, and 1102e is removed from section 810. For example, as shown in FIG. 12 pointer 712 is shown positioned over delete button 1208. Delete button 1208 may be “clicked” by interaction by pointer 712, to remove advertisement 1102e from section 810. In such a case, advertisements 1102b and 1102c may be trafficked to the “Sports Males” ad group if assign button 1004 is interacted with, while advertisement 1102e is not trafficked to the “Sports Males” ad group.

Page 800 may be configured to enable advertisements listed in section 808 to be previewed by users. For example, user 602 may desire to preview advertisements listed in section 808 to aid in determining whether to traffic particular advertisements to an ad group. In an embodiment, as shown in FIG. 13, user 602 may be enabled to interact with an advertisement listed in section 808 using pointer 712 to preview the advertisement. As shown in FIG. 13, when pointer 712 is positioned over the name “Ad 26” of advertisement 1102f, the name “Ad 26” becomes underlined, indicating that advertisement 1102f may be selected for preview. If user 602 clicks on the underlined name, advertisement 1102f may be displayed. For example, FIG. 14 shows a view of page 800, where an advertisement image 1402 is shown displayed over page 800. Advertisement image 1402 is the graphical representation of advertisement 1102f. After viewing advertisement image 1402, user 602 may close the displayed image 1402 (e.g., by using pointer 712 to interact with a close button displayed in an upper-right corner of image 1402 in FIG. 14).

In another embodiment, FIG. 15 shows page 800, where user 602 has interacted with pull down menu button 822 to display a menu 1502 of advertisement sources that can be displayed, including recommended ads (as described above), high performer ads (which may be ads selected according to their click-through-rate (CTR) performance and/or other performance metrics), and an ad library. In the example of FIG. 15, user 602 is using pointer 712 to interact with the ad library selection of menu 1502. If “ad library” is selected in menu 1502, an ad library navigator window 1602 may be displayed over page 800, as shown in FIG. 16. Ad library navigator window 1602 is configured to enable user 602 to navigate through an advertisement library directory structure, to select a particular advertisement library folder to display the advertisements contained in the folder. In the example of FIG. 16, the advertisement library folder hierarchy shown in FIG. 7 is displayed, including in a top level folder labeled “Ad Library,” which contains the folders “Holiday 07,” “Trends 07,” and “Styles” as subfolders, and the folder “Holidays 07” including the folders labeled “Thanksgiving” and “Winter.” User 602 may select one of the folders (e.g., using pointer 712, not shown in FIG. 16) to view a listing of the advertisements contained by the folder in section 808 of page 800.

For instance, FIG. 17 shows a view of page 800, where the folder “Winter” was selected. As shown in FIG. 17, a folder name indication 1714 (“Winter”) is provided in page 800. Furthermore, six advertisements 1702a-1702f, which are contained in the “Winter” folder, are shown displayed in section 808. Any of advertisements 1702a-1702f may be selected for assignment to the “Sports Males” ad group (and/or other ad group), as described above.

In an embodiment, selecting an online advertisement (according to step 504) may be performed with regard to an ad library, such as shown in FIG. 17, according to FIG. 18. FIG. 18 shows a flowchart 1800 for enabling an online advertisement to be selected from a plurality of online advertisements, according to an example embodiment of the present invention. Flowchart 1800 is described as follows.

Flowchart 1800 begins with step 1802. In step 1802, an advertisement library containing a plurality of folders is enabled to be displayed. For example, as described above with respect to FIG. 15, user 602 may be enabled (e.g., by user interface 604 of FIG. 6) to display a menu 1502 of advertisement sources that can be displayed, including an ad library. User 602 is enabled to use pointer 712 to interact with the ad library selection of menu 1502 to display an ad library navigator window 1602 over page 800, as shown in FIG. 16.

In step 1804, a user is enabled to select a folder of the plurality of folders. For example, as described above, ad library navigator window 1602 is configured to enable user 602 to navigate through an advertisement library directory structure, to select a particular advertisement library folder to display the advertisements contained in the folder.

In step 1806, a plurality of online advertisements included in the selected folder is displayed. For example, as shown in FIG. 17, six advertisements 1702a-1702f, which are contained in the “Winter” folder, are shown displayed in section 808 as a result of selecting the “Winter” folder in step 1804.

In step 1808, the online advertisement is enabled to be selected from the displayed plurality of online advertisements. For example, as described above with respect to FIG. 17, any of advertisements 1702a-1702f may be selected for assignment to the “Sports Males” ad group (and/or other ad group).

In an embodiment, the contents of an ad group may be indicated to a user. For instance, as shown in FIG. 17, page 800 may include a “view details” button 1006. By interacting with (e.g., clicking on) button 1006, user 602 may be enabled to display the contents of the active ad group, which is the “Sports Males” ad group in the example of FIG. 17. FIGS. 19 and 20 show views of an ad group details page 1900 which may be displayed in response to user 602 interacting with button 1006, according to an example embodiment. Page 1900 shows example details that may be present for the “Sports Males” ad group. As shown in FIG. 19, page 1900 includes a header section 1902, a body section 1904, and a close button 1926. Header section 1902 includes a schedule section 1908, an amount section 1910, an audience targeting section 1912, and an ad properties section 1914. Body section 1904 includes a display selector section 1920 and a listing section 1928. Any of these sections may or may not be present in page 1900, in embodiments.

Schedule section 1908 displays schedule information (e.g., a date range, such as Feb. 1, 2008-Feb. 15, 2008) for the advertisement campaign corresponding to the active order and ad group, which in the example of FIGS. 19 and 20 are the “Toyota Holidays” order and the “Sports Males” ad group. Amount section 1910 displays a monetary amount (e.g., $850.00) that may be a cost of the active order, and a number of placements included (e.g., 17,000) available in the active order. Audience targeting section 1912 displays target audience attributes (e.g., a sex demographic of male, age group of 18-24, a location of California, and subject matter of “browsing in Automotive/SUV/, classified/Toyota/SUVs”) of the active ad group. Ad properties section 1914 displays advertisement properties (e.g., rich media format, North banner position, and an advertisement size of 150×600 pixels) for the active ad group.

Listing section 1928 displays a list of advertisements assigned to the ad group, or a list of placements associated with the ad group, based on a selection made in display selector section 1920. Section 1920 is shown in FIG. 19 as including a display selector box 1916 and a pull down menu button 1918. User 602 shown in FIG. 6 may interact with pull down menu button 1918 to select “Ads” or “Placements,” to cause a list of advertisements assigned to the ad group or a list of placements associated with the ad group to be displayed in listing section 1928. For instance, in FIG. 19, “Ads” is selected in display selector box 1916. Thus, listing section 1928 displays a list of the two advertisements 1922 and 1924 that are included in the “Sports Males” ad group. In the example of FIG. 19, listing section 1928 includes multiple columns, including a name column, an ad size column, a format column, a date assigned by column, a person assigned by column, and an alert column, which may each include corresponding data for each advertisement. Note that although two advertisements are shown in FIG. 19 for the “Sports Males” ad group, any number of advertisements may be associated with an ad group, in embodiments.

FIG. 20 shows a view of page 1900, where “Placements” is selected in ad selector box 1916. As such, listing section 1928 displays a list of seven placements 2004, 2006, 2008, 2010, 2012, 2014, and 2016 that are included in the “Sports Males” ad group. In the example of FIG. 20, listing section 1928 includes multiple columns, including a network column, a status column, a site column, a category column, an ad size column, and a flight date column, which may each include corresponding data for each placement. Note that although seven placements are shown in FIG. 20 for the “Sports Males” ad group, any number of placements may be associated with an ad group, in embodiments.

D. Advertisement Specification Embodiments

Note that in an embodiment, an advertisement specification may be associated with an ad group based on the associated advertisement placements. For example, as described above, one or more advertisement properties may be associated with an ad group that are descriptive of the advertisement placements included in the ad group.

Examples of such advertisement attributes include an advertisement size, an advertisement weight, or an advertisement format. Advertisement size is representative of the dimensions of an advertisement. For example, online advertisement 1702a listed in FIG. 17 has an area of 200 pixels by 600 pixels.

Advertisement weight represents an amount of storage (e.g., a number of bytes) necessary to store the online advertisement. Advertisement format is representative of the technique used to compress or organize the contents of the online advertisement.

Example formats include but are not limited to Adobe® Flash®, Graphics Interchange Format (GIF), JPEG, rich media, etc. For example, online advertisement 1702a listed in FIG. 17 has an advertisement format of rich media.

Typically, online advertisements that are trafficked into an ad group meet the advertisement specification associated with the ad group. For example, advertisement 1924 associated with the “Sports Males” ad group in FIG. 19 meets the advertisement properties associated with the “Sports Males” ad group that are indicated by ad properties section 1914. As shown in FIG. 19, advertisement 1924 has properties of a rich media format, is suitable for a North banner position, and has a size of 728×90, each of which meet the properties indicated in ad properties section 914. However, in an embodiment, online advertisements that violate one or more properties of the advertisement specification associated with an ad group may be trafficked into the ad group. For instance, as shown in FIG. 19, advertisement 1922 is associated with the “Sports Media” ad group, but has a size of 200×600, which violates the ad group size property of 728×90 indicated in ad properties section 914.

As such, advertisement 1922 may not be supplied by the “Sports Media” ad group for display in response to an impression request related to an advertisement placement of the “Sports Media” ad group. Despite this, advertisement 1922 is associated with the “Sports Males” ad group.

Enabling advertisements that violate one or more properties of an advertisement specification of an ad group to be trafficked into the ad group may have benefits. For example, additional placements may be associated with the ad group subsequent to trafficking advertisements into the ad group that violate the original advertisement specification of the ad group. The additional placements may revise the advertisement specification for the ad group (e.g., modifying the ad size, ad format, and/or ad weight properties) such that the formerly violating advertisements meet the revised advertisement specifications of the ad group. For example, referring to the “Sports Males” ad group indicated in FIG. 19, if an advertisement placement having an ad size property of 200×600 is added to the “Sports Males” ad group, advertisement 1922 no longer violates the advertisement specification of the “Sports Males” ad group, as the 200×600 ad size of advertisement 1922 meets the ad size property of 200×600 of the new placement (assuming that advertisement 1922 meets the other properties of the new ad placement).

It is noted that in embodiments, placements associated with an ad group may be able to expire. For instance, as indicated in FIG. 20, an advertisement placement may have a “flight date” during which the advertisement is active, and after expiration of the flight date, the advertisement placement expires. In such an embodiment, an advertisement that formerly met the advertisement specification for an ad group may violate the advertisement specification of the ad group after such expiration, if no remaining advertisement placements in the ad group enable the advertisement to meet the advertisement specifications of the ad group.

### III. Example Computer Implementations

The embodiments described herein, including systems, methods/processes, and/or apparatuses, may be implemented using well known servers/computers, such as a computer 2100 shown in FIG. 21. For example, embodiments of advertisement trafficking system 306 of FIG. 3 (e.g., advertisement trafficking systems 400 and 600 of FIGS. 4 and 6, respectively) can be implemented using one or more computers 2100.

Computer 2100 can be any commercially available and well known computer capable of performing the functions described herein, such as computers available from International Business Machines, Apple, Sun, HP, Dell, Cray, etc. Computer 2100 may be any type of computer, including a desktop computer, a server, etc.

Computer 2100 includes one or more processors (also called central processing units, or CPUs), such as a processor 2104. Processor 2104 is connected to a communication infrastructure 2102, such as a communication bus. In some embodiments, processor 2104 can simultaneously operate multiple computing threads.

Computer 2100 also includes a primary or main memory 2106, such as random access memory (RAM). Main memory 2106 has stored therein control logic 2128A (computer software), and data.

Computer 2100 also includes one or more secondary storage devices 2110. Secondary storage devices 2110 include, for example, a hard disk drive 2112 and/or a removable storage device or drive 2114, as well as other types of storage devices, such as memory cards and memory sticks. For instance, computer 2100 may include an industry standard interface, such a universal serial bus (USB) interface for interfacing with devices such as a memory stick. Removable storage drive 2114 represents a floppy disk drive, a magnetic tape drive, a compact disk drive, an optical storage device, tape backup, etc.

Removable storage drive 2114 interacts with a removable storage unit 2116. Removable storage unit 2116 includes a computer useable or readable storage medium 2124 having stored therein computer software 2128B (control logic) and/or data. Removable storage unit 2116 represents a floppy disk, magnetic tape, compact disk, DVD, optical storage disk, or any other computer data storage device. Removable storage drive 2114 reads from and/or writes to removable storage unit 2116 in a well known manner.

Computer 2100 also includes input/output/display devices 2122, such as monitors, keyboards, pointing devices, etc.

Computer 2100 further includes a communication or network interface 2118. Communication interface 2118 enables the computer 2100 to communicate with remote devices. For example, communication interface 2118 allows computer 2100 to communicate over communication networks or mediums 2142 (representing a form of a computer useable or readable medium), such as LANs, WANs, the Internet, etc. Network interface 2118 may interface with remote sites or networks via wired or wireless connections.

Control logic 2128C may be transmitted to and from computer 2100 via the communication medium 2142.

Any apparatus or manufacture comprising a computer useable or readable medium having control logic (software) stored therein is referred to herein as a computer program product or program storage device. This includes, but is not limited to, computer 2100, main memory 2106, secondary storage devices 2110, and removable storage unit 2116. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable media may store program modules that include computer program logic for implementing advertisement trafficking system 306, advertisement trafficking system 400, advertisement trafficking module 402 (FIG. 4), advertisement trafficking module 600, user interface 604 (FIG. 6), ad group modifier module 606 (FIG. 6), flowchart 500 (FIG. 5), step 902 (FIG. 9), and/or flowchart 1800 of FIG. 18 (including any one or more steps of flowcharts 500 and 1800), and/or further embodiments of the present invention described herein. Embodiments of the invention are directed to computer program products comprising such logic (e.g., in the form of program code or software) stored on any computer useable medium. Such program code, when executed in one or more processors, causes a device to operate as described herein.

The invention can work with software, hardware, and/or operating system implementations other than those described herein. Any software, hardware, and operating system implementations suitable for performing the functions described herein can be used.

### IV. Conclusion

While various embodiments of the present invention have been described above, it should be understood that they have been presented by way of example only, and not limitation. It will be apparent to persons skilled in the relevant art(s) that various changes in form and details may be made to the embodiments described above without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1 A method for trafficking online advertisements, comprising:
receiving an indication of an ad group, the ad group having an associated plurality of advertisement placements;
receiving an indication of an online advertisement; and
associating the indicated online advertisement with the indicated ad group.

2. The method of claim 1, wherein an advertisement specification is associated with the ad group based on the associated plurality of advertisement placements, wherein the indicated online advertisement violates the advertisement specification, wherein said associating comprises:
associating the indicated online advertisement with the indicated ad group even though the indicated online advertisement violates the advertisement specification.

3. The method of claim 2, wherein the advertisement specification may include an advertisement size, an advertisement weight, or an advertisement format.

4. The method of claim 1, wherein said receiving an indication of an online advertisement comprises:
enabling the online advertisement to be selected from a plurality of online advertisements; and
wherein said receiving an indication of an ad group comprises:
enabling the ad group to be selected from a plurality of ad groups.

5. The method of claim 4, wherein said enabling the ad group to be selected from a plurality of ad groups comprises:
enabling the ad group to be selected from the plurality of ad groups in response to the online advertisement being selected.

6. The method of claim 4, wherein said enabling the online advertisement to be selected from a plurality of online advertisements comprises:
enabling an advertisement library containing a plurality of folders to be displayed;
enabling a user to select a folder of the plurality of folders;
displaying a plurality of online advertisements included in the selected folder; and
enabling the online advertisement to be selected from the displayed plurality of online advertisements.

7. The method of claim 1, further comprising:
enabling the indicated online advertisement to be removed from the indicated ad group.

8. A system, comprising:
a user interface configured to enable an ad group and an online advertisement to be selected, the selected ad group having an associated plurality of advertisement placements; and
an ad group modifier module configured to associate the selected online advertisement with the selected ad group.

9. The system of claim 8, wherein an advertisement specification is associated with the ad group based on the associated plurality of advertisement placements, wherein the indicated online advertisement violates the advertisement specification, wherein the ad group modifier module is configured to associate the indicated online advertisement with the indicated ad group even though the indicated online advertisement violates the advertisement specification.

10. The system of claim 9, wherein the advertisement specification may include an advertisement size, an advertisement weight, or an advertisement format.

11. The system of claim 8, wherein the user interface is configured to enable the online advertisement to be selected from a plurality of online advertisements, and to enable the ad group to be selected from a plurality of ad groups.

12. The system of claim 11, wherein the user interface is configured to enable the ad group to be selected from the plurality of ad groups in response to the online advertisement being selected.

13. The system of claim 11, wherein the user interface is configured to enable an advertisement library containing a plurality of folders to be displayed, to enable a user to select a folder of the plurality of folders, to display a plurality of online advertisements included in the selected folder, and to enable the online advertisement to be selected from the displayed plurality of online advertisements.

14. The system of claim 8, wherein the user interface is configured to enable the online advertisement to be selected for removal from the indicated ad group, and wherein the ad group modifier module is configured to remove the online advertisement from the indicated ad group in response to the online advertisement being selected for removal.

15. A computer program product comprising a computer-readable medium having computer program logic recorded thereon for enabling a processor to traffic advertisements, comprising:
first computer program logic means for enabling the processor to receive an indication of an ad group, the ad group having an associated plurality of advertisement placements;
second computer program logic means for enabling the processor to receive an indication of an online advertisement; and
third computer program logic means for enabling the processor to associate the indicated online advertisement with the indicated ad group.

16. The computer program product of claim 15, wherein an advertisement specification is associated with the ad group based on the associated plurality of advertisement placements, wherein the indicated online advertisement violates the advertisement specification, wherein the third computer program logic means comprises:
fourth computer program logic means for enabling the processor to associate the indicated online advertisement with the indicated ad group even though the indicated online advertisement violates the advertisement specification.

17. The computer program product of claim 16, wherein the advertisement specification may include an advertisement size, an advertisement weight, or an advertisement format.

18. The computer program product of claim 15, wherein the second computer program logic means comprises:
fourth computer program logic means for enabling the processor to enable the online advertisement to be selected from a plurality of online advertisements; and wherein the first computer program logic means comprises:
fifth computer program logic means for enabling the processor to enable the ad group to be selected from a plurality of ad groups.

19. The computer program product of claim 18, wherein the fifth computer program logic means comprises:
sixth computer program logic means for enabling the processor to enable the ad group to be selected from the plurality of ad groups in response to the online advertisement being selected.

20. The computer program product of claim 18, wherein the fourth computer program logic means comprises:
sixth computer program logic means for enabling the processor to enable an advertisement library containing a plurality of folders to be displayed;
seventh computer program logic means for enabling the processor to enable a user to select a folder of the plurality of folders;
eighth computer program logic means for enabling the processor to display a plurality of online advertisements included in the selected folder; and
ninth computer program logic means for enabling the processor to enable the online advertisement to be selected from the displayed plurality of online advertisements.

21. The computer program product of claim 15, further comprising:
fourth computer program logic means for enabling the processor to enable the indicated online advertisement to be removed from the indicated ad group.
